(19) United States
(12) Patent Application Publication
(10) Pub. No.: US 2024/0315225 A1
(43) Pub. Date: Sep. 26, 2024

(54) FISHING LINE WEIGHT

(71) Applicant: Laurence Powell, Vancouver (CA)

(72) Inventor: Laurence Powell, Vancouver (CA)

(21) Appl. No.: 18/187,855

(22) Filed: Mar. 22, 2023

(51) Int. Cl. A01K 95/02; A01K 95/00

(52) U.S. Cl. CPC A01K 95/02; A01K 95/005

(57) ABSTRACT

A fishing line weight that is configured to be releasably secured to a fishing line wherein the present invention is operable to employ organic materials having a mass sufficient to sink a bait assembly to a desired level in the water column or to the bottom. The present invention includes a bag member wherein the bag member includes opposing walls that are seamed along the perimeter edge thereof on three sides of the bag member to form an interior volume. The interior volume is of suitable size to accommodate rocks or other organic materials therein. The bag member includes an opening proximate the top end thereof providing access to the interior volume. The bag member can employ a closing member that is similar to a drawstring to provide opening and closing of the opening. A loop member or an aperture can be present to facilitate attachment to a fishing line.

### FIELD OF THE INVENTION

The present invention relates generally to fishing equipment, more specifically but not by way of limitation, a fishing weight that is configured to be releasably secured to a fishing line wherein the weight of the present invention includes a bag member having a cavity to receive and store weight members such as but not limited to rocks therein.

### BACKGROUND

As is known in the art, fishing is participated in by millions of people worldwide. The commercial fishing industry is a multi-billion dollar a year industry and the recreational fishing industry is also a multi-billion dollar a year industry. Recreational fishing employs various tactics and equipment but the most widely utilized equipment for recreational fishing is a rod and reel. Rod and reels utilize line, typically monofilament or some other suitable line material to deploy bait which can be natural or artificial. There are different tactics with rod and reels but one widely utilized tactic is referred to as bottom fishing wherein the bait, coupled to a hook, is held at or near the bottom with a weight.

There are different techniques to secure the weight to the line and the proximity to the bait can vary but for bottom fishing at least one weight is secured to the line. There are numerous types of weight but almost all fishing weights are manufactured from lead as this leads to a lower cost for the consumer to purchase the fishing weight. Hundreds of thousands of lead weights and other fishing tackle is lost during fishing as various events can cause the line to snap or the fishing weights to be removed. This results in millions of pounds of toxic lead being left in the water every year.

Accordingly, there is a need for a fishing weight that can be releasably secured to a fishing line wherein the fishing weight of the present invention is configured to employ organic material such as but not limited to rocks to function to maintain the bait at or near the bottom during fishing.

### SUMMARY OF THE INVENTION

It is the object of the present invention to provide a fishing weight that is configured to be releasably secured to a fishing line wherein the present invention includes a bag member.

Another object of the present invention is to provide a weight to be employed during fishing and configured to be releasably secured to the fishing line wherein the bag member includes walls that are manufactured from a biodegradable material.

A further object of the present invention is to provide a fishing weight that is configured to be releasably secured to a fishing line wherein the walls of the bag member are structured to form an interior volume for the bag member.

Yet a further object of the present invention is to provide a weight to be employed during fishing and configured to be releasably secured to the fishing line wherein the interior volume is accessible via an opening and configured to receive heavy organic material therein such as but not limited to rocks.

Still another object of the present invention is to provide a fishing weight that is configured to be releasably secured to a fishing line wherein the opening to the bag member is configured to be resealed subsequent depositing heavy organic material in the interior volume of the bag member.

An additional object of the present invention is to provide a weight to be employed during fishing and configured to be releasably secured to the fishing line wherein an embodiment of the present invention can employ a drawstring around the opening to provide opening and closing thereof.

Yet a further object of the present invention is to provide a fishing weight that is configured to be releasably secured to a fishing line wherein an embodiment of the present invention can deploy a loop or aperture to secure the bag member to a fishing line.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention; and

FIG. 2 is a frontview of an embodiment of the present invention; and

FIG. 3 is a frontview of an embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a fishing line weight 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the fishing line weight 100 is configured to be releasably secured to a fishing line wherein the fishing line weight 100 will provide the necessary mass to sink the fishing line weight 100 and a bait assembly nearby to a desired depth. It should be understood within the scope of the present invention that the fishing line weight 100 could be deployed with mass so as to suspend a bait assembly at a desired depth in the water column or have sufficient mass to deliver the bait assembly to the bottom of the area in which the user is fishing.

The fishing line weight 100 includes a bag member 10 wherein the bag member 10 is comprised of wall members 11,12. Wall members 11,12 are joined along the perimeter edge 15 so as to form an interior volume. In a preferred embodiment the bag member 10 is manufactured from a biodegradable material. Walls members 11, 12 are porous so as to inhibit providing any flotation to the fishing line weight 100 during use thereof. It is contemplated within the scope of the present invention that the bag member 10 could be manufactured in alternate sizes and shapes. The bag member 10 is manufactured of suitable size so as to receive therein organic material such as but not limited rocks. The fishing line weight 100 is configured to receive into the interior volume materials having mass such as but not limited to rocks so as to provide the necessary weight to achieve the objects discussed herein. It should be understood within the scope of the present invention that the fishing line weight 100 could have disposed therein various materials in place of and/or in conjunction with rocks in order to achieve the desired objective discussed herein.

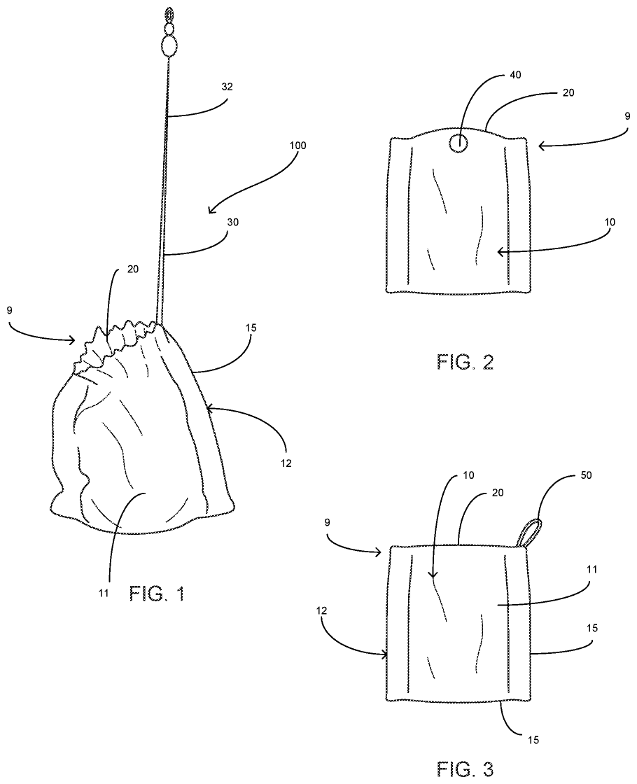

The bag member 10 includes opening 20 proximate a top end 9 thereof wherein the opening 20 is configured to provide access to the interior volume of the bag member 10 in order to facilitate placement of mass material therein. While the opening 20 is illustrated herein as being proximate the top end 9, it should be understood within the scope of the present invention that the opening 20 could be formed on alternate parts of the bag member 10 and achieve the desired objective discussed herein. The embodiment of the fishing line weight 100 illustrated herein in FIG. 1 includes a closing member 30 wherein the closing member 30 is a drawstring that provides an ability to open and close the opening 20 in order to access the interior volume of the bag member 10. It should be understood within the scope of the present invention that the closing member 30 could be manufactured employing alternate elements such as but not limited to hook and loop material proximate the top end 9 of the bag member 10 in order to provide opening and closing of the opening 20.

As it pertains to the embodiment illustrated herein in FIG. 1, the closing member 30 includes portion 32 that can be employed for securing to a fishing line utilizing a suitable conventional knot. Referring in particular to FIG. 2, the bag member 10 includes an aperture 40 formed in the walls thereof. Aperture 40 is configured to have a fishing line journaled therethrough so as to provide securing to the fishing line. The embodiment of the fishing line weight 100 illustrated herein in FIG. 3 includes a loop member 50 wherein the loop member 50 is secured to the bag member 10 utilizing suitable durable techniques. Loop member 50 provides an element to which a fishing line can be tied or journaled therethrough. It should be understood within the scope of the present invention that the loop member 50 and aperture 40 could be provided in alternate sizes as well as place in alternate locations on the bag member 10.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A fishing line weight configured to be releasably secured to a fishing line wherein the fishing line weight comprises:
a bag member, said bag member having a first wall member and a second wall member, said first wall member and said second wall member being operably coupled along a perimeter edge, said bag member having an interior volume, said bag member having an opening providing access to said interior volume, said interior volume configured to have an organic material disposed therein wherein the organic material has sufficient mass to sink in water; and
said bag member being manufactured from a biodegradable material.

2. The fishing line weight configured to be releasably secured to the fishing line as recited in claim 1, wherein said opening is proximate a top end of said bag member.

3. The fishing line weight configured to be releasably secured to the fishing line as recited in claim 1, and further including a closing member, said closing member proximate said opening, said closing member configured to provide opening and closing of said opening.

4. The fishing line weight configured to be releasably secured to the fishing line as recited in claim 1, wherein said bag member further includes an aperture journaled therethrough, said aperture being proximate the top end of said bag member, said aperture operable to receive a fishing line therethrough.

5. The fishing line weight configured to be releasably secured to the fishing line as recited in claim 1, wherein said bag member further includes a loop member secured thereto, said loop member being proximate the perimeter edge said bag member, said loop member operable to receive a fishing line therethrough.

6. The fishing line weight configured to be releasably secured to the fishing line as recited in claim 1, wherein the interior volume of said bag member is configured to receive at least one rock therein.
